(19) United States
(12) Patent Application Publication
(10) Pub. No.: US 2014/0047880 A1
(43) Pub. Date: Feb. 20, 2014

(54) Methods of Processing Food Waste

(71) Applicant: Lloyd Myles Phipps, Shelton, WA (US)

(72) Inventor: Lloyd Myles Phipps, Shelton, WA (US)

(21) Appl. No.: 13/971,641

(22) Filed: Aug. 20, 2013

Related U.S. Application Data
(60) Provisional application No. 61/742,783, filed on Aug. 20, 2012.

(51) Int. Cl. C05F 1/00

(52) U.S. Cl. CPC C05F 1/005
USPC 71/8; 71/16

(57) ABSTRACT

This disclosure describes, in part, methods of making compost by combining shellfish waste and fruit waste. In some implementations, the shellfish waste contains chitin and calcium carbonates and the addition of the fruit waste may provide a deodorizing function as well as a de-carbonization reaction to the shellfish waste. In other implementations, where chitin may not be present the shellfish waste, the addition of the fruit waste may produce useful calcium salts and/or the calcium content. In some implementations, the methods may allow for production of compost that is odorless.

### CROSS REFERENCE TO RELATED APPLICATION

This claims priority to U.S. Provisional Patent Application No. 61/742,783 filed on Aug. 20, 2012 entitled “Blends of shellfish waste materials and fruit waste material for efficient chemical generation of useful products, improved composting means, and sustainable methods,” which is hereby incorporated by reference in its entirety.

### BACKGROUND

The shellfish industry generates many millions of pounds of by-products worldwide every year, especially shells and other exoskeleton parts. Generally, shellfish (i.e crabs, shrimp, oysters clams, lobsters, mussels, abalone, scallop, crayfish, sea snails, limpet, and the like) which are mobile in lifestyle have an exoskeleton that provides protection to the individual organism, but which must be removed during the production of the edible fraction of the organism after harvesting by the seafood industry. These protective shells are a source of various valuable materials of commercial potential, the extraction of which has been widely explored. Among the products with commercial potential are the natural dyes found in crab shells. Additionally, proteins and other organic materials that adhere to the shells after removal of the bulk edible tissue, are usable in various ways. Importantly, however, it is these residual materials that are susceptible to spontaneous decay-related processes that are responsible for the development of odors typically associated with the shellfish storage and/or waste products. In many locations, environmental regulations have limited the shellfish processing industries from simply returning the shell waste to the oceans, causing a need for land-based processing and storage. A useful commercial product that could efficiently utilize these wastes is needed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example flow diagram of a process for food waste including shellfish waste and fruit waste.

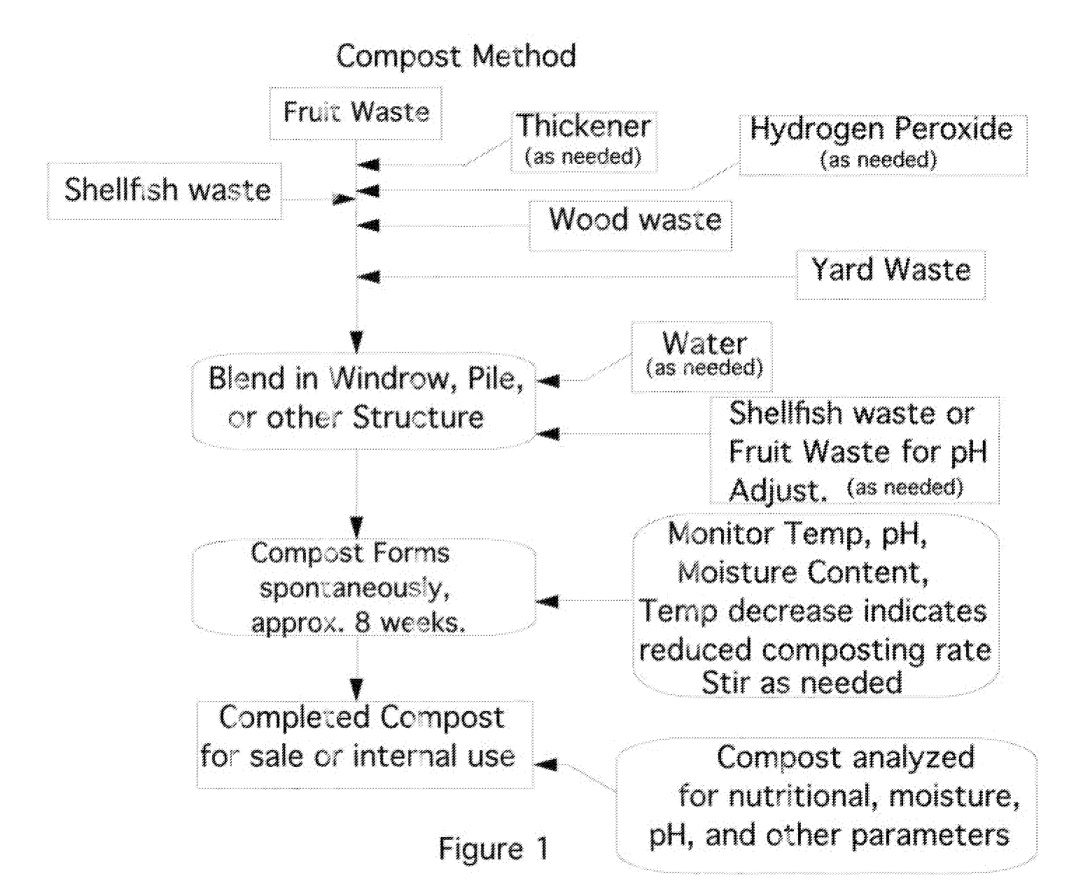

FIG. 2 illustrates an example flow diagram of a process for isolation of chitin and calcium Acetate from food waste including shellfish waste and fruit waste.

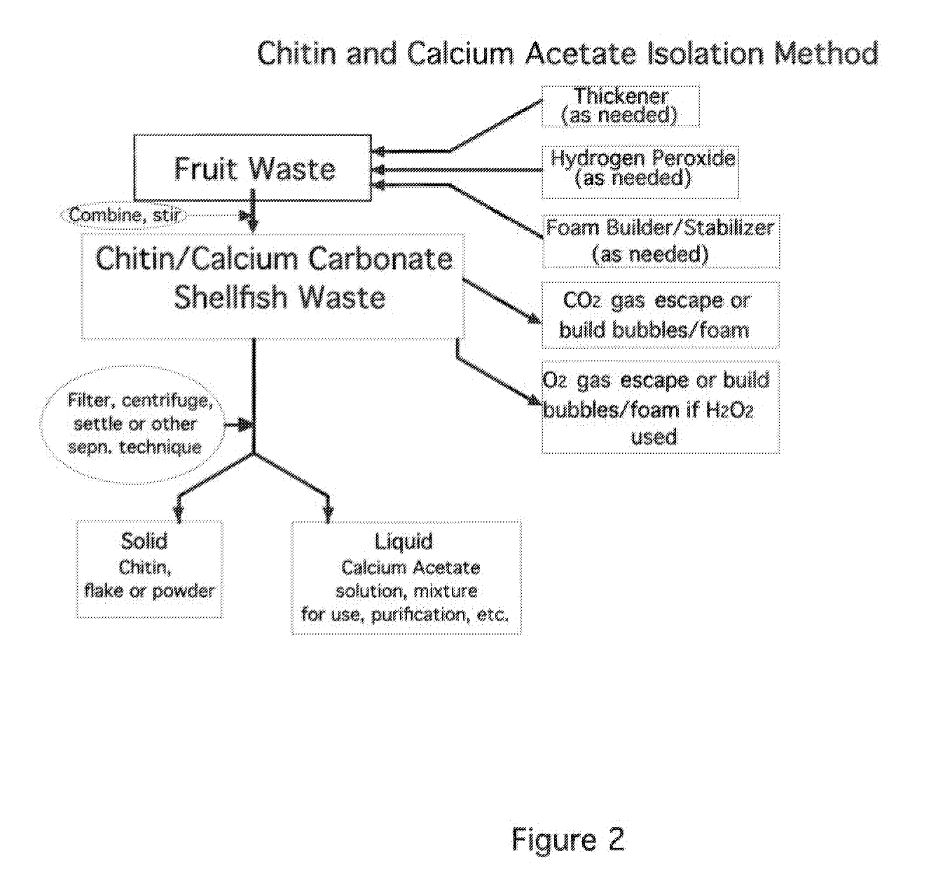

FIG. 3 illustrates a bar graph illustrating an odor test as indicated by the number of fly visits of various combinations of the food waste including shellfish waste and fruit waste.

FIG. 4 illustrates a bar graph illustrating the effectiveness of various thickeners to combinations of the food waste including shellfish waste and fruit waste.

### DETAILED DESCRIPTION

### Overview

Shellfish waste components are present in larger amounts. These materials are of two general types, and the amount present in the shells of various species varies considerably. In some species, for example crabs, the shells are made of a composite of inorganic material, primarily calcium carbonate (CaCO₃) and a relatively complex organic phase polysaccharide called chitin ((C₈H₁₈O₅N)ₙ). It is also known that the content of chitin and carbonate varies within the various anatomy zones of the organism. Other species, for example, shrimp lack the calcium carbonate component and consist primarily of the chitin component only. A third general class of shells, for example oyster shells, are composed almost entirely of calcium carbonate with essentially no chitin present.

Calcium carbonate can be removed from the chitin by a number of known processes. The most common of these is to utilize the well known acid reaction with calcium carbonate, as shown schematically as:

For monovalent X:

2HX (an acid)+CaCO₃→CaX₂+CO₂+H₂O. REACTION 1A

Alternatively, for divalent X:

H₂X+CaCO₃→CaX+CO₂+H₂O REACTION 1B

It is to be understood by persons familiar with the art, other X-valencies are also usable with corresponding changes in the stoichiometry of the reaction. These reactions as shown are, in effect, schematic representations. Further, it is to be understood that this invention contemplates that the chemical agents (i.e., food waste) utilized are not pure substances and that the reactions shown are intended as summarizations of the processes that are occurring in a complex mixture of compounds that are present in a waste product. It is to be further understood that the complex mixture of materials present in the waste product can include a variety of acidic materials, both organic and inorganic, and that within this complex mixture might be a number of acidic materials capable of acting as the acid of Reaction 1. All such reactions are included in the contemplated invention and are thus claimed. Although the primary acidic waste product of the instant invention is fruit waste, other acidic waste could be substituted if sufficient quantities were available. Mixed fruit wastes are also contemplated as are mixtures of fruit waste with other wastes such as agricultural field waste, orchard ground waste and the like.

Persons familiar with the art will recognize that the precise nature of the fruit waste can vary because of a number of factors. For example, the geography of available food crops, the local agricultural conditions, and the various agricultural and food processing variability. These variables can result in a variety of acidic materials being present in the fruit waste. As the acidic content of the fruit waste varies, the reactivity of the fruit waste relative to the calcium carbonate will similarly vary, and of course the amount of calcium salt will vary accordingly as well. All this variability is contemplated by the invention and is similarly claimed.

When reaction 1A and/or 1B is done on the calcium carbonate embedded within the shell structure the reaction proceeds smoothly, carbon dioxide bubbles are released, and the organic components, particularly chitin (an insoluble solid) are left behind. Filtration or other known techniques can then be used to separate the solution of Ca-salt (organic or inorganic) from the chitin. In some implementations, a solution left over after crystallization can then be processed using well-known techniques to purify and isolate the soluble materials. Additionally, the solid chitin remaining after filtration can be processed by known techniques to yield other useful products. The shells of crustaceans can be in any usable form, ranging from unprocessed simple shells, containing selected anatomical parts, shells from whole-body tissue extraction, crushed shells, shell meal from extensive crushing or grinding, rolled shells or mixtures thereof In some implementations, the shells from single or multiple species are also contemplated in any usable form. Generally, finer grinds of shells would react at greater rates because of the greater exposed areas on the finer grinds. Other factors involved in the de-carbonation reaction, temperature, acid type, acid concentration, acid reactive potential, or the like may be of greater significance than shell particle size.

### Chitin Properties

Structurally, chitin is an organic polymer in the polysaccharide family. Chitin's most common form differs only slightly from that of the earth's most common organic material: cellulose. The difference, specifically the presence of an N-acetylamino group as a replacement of one —OH function that is found on each glucose monomer in the chain of cellulose, while seemingly minor, results in the distinct and unique set of properties of chitin relative to cellulose. Apparently, chitin is readily available to the world's organisms through energetically favorable pathways, and is thus ubiquitous, forming the shells of many organisms. It is the main component of the carapace of insects, is found in cell walls of many plant and fungal organisms, in a number of microorganisms (as discussed below), and of course, in aquatic organisms like crustaceans. Chitin is believed to be the second-most abundant organic material on Earth, behind only cellulose in quantity. It is a water-insoluble polymer. It has a number of industrially and agriculturally interesting properties, and has formed the basis of a large body of technology. In addition to its own physio-chemical properties, chitin has been subject to a variety of modifications involving many transformations, utilizing techniques and reactions typical of other polymers which might share some features of the chitin. Chitin can be treated as a typical polysaccharide or polyglycoside. Reactions that have been widely studied include chain-shortening (i.e. partial depolymerization) and deacetylation to produce the corresponding polyaminoglucose derivative, also known as chitosan. The deacetylation reaction is generally catalyzed by alkali in aqueous solution: A typical alkali is sodium hydroxide as illustrated:

Chitin+NaOH (aq)→chitosan+NaOAc (sodium acetate) REACTION 2

Chitosan is also widely used, partly because it is a much more tractable material, being soluble in a variety of solvents, including water. It can be cast as film, can act as a binder, has some adhesive properties, provides an anti-fungal and/or anti-mold action when applied to fruit, pre-harvest or post-harvest, helps hold moisture in agricultural applications and many other uses. Chitosan (and chitin itself) is also non-toxic to humans, and acts as a polymeric source from which N-Acetylglucosamine, a commonly used over-the-counter supplement (glucosamine) is obtained.

It should be mentioned here that shellfish and insect carapaces are not the only significant sources of chitin and chitosan. To avoid some of the practical difficulties associated with the commercialization of chitin and chitosan (transportation and supply issues among them) a number of microbial organisms have been studied. Both chitin and chitosan can be found in the cell walls of a number of microorganisms, including native wild-type and genetically modified species. In the future, these approaches might become dominant in the market, but at the current time, the shellfish-derived forms are still important.

Other ingredients of discarded shellfish shells can include, for example, those of oysters. Application of the instant invention can include embodiments wherein the shells from low-chitin or chitin-free organisms are used with the fruit waste solution. In those cases, the products will not include significant amounts of chitin, but can include products derived from the fruit waste components reacting with a variety of shell-based compounds. For example, oyster shells are known to contain: Calcium carbonate and Silicate; In some implementations, the product of the present invention also contains many other ingredients including Aspartic acid; Glycine; Serine; Eicosapentaenoic acid; Decosahexemoic acid; Calendic acid; Octadecadienoic acid; Eicosatetraenoic acid; Calcium phosphate; Calcium sulfate; Glutamic acid; Taurine; Glycogen; Glutathione; Linolenic acid; Linolic acid; Glucose; Fucose; Aminohexose; Methyl pentose; Cysteine; Ferric oxide; Zinc; Manganese; Barium; Phosphorus; Calcium; Copper; Cobalt; Cadmium; Nickel; Lead; Silicon; Aluminum; Magnesium; Potassium; Chromium; Iron; Selenium; Molybdenum; Strontium; Titanium; Vitamins A, B 1, B2, D, and E.

In some implementations, the acidic components mentioned above, even though they might be present is small percentages will also be included in the extractive solution, and are therefore included in the liquid or the dried solid, primarily salt mixture that results. If economic motivations are present, they could be isolated as pure products or simplified mixtures using techniques known to those familiar with the art. For example, the calcium salt of octadecadienoic acid might be commercially available from this source. The above summary of components is intended to illustrate the results of studies of oyster shells. Similar studies have been performed on a variety of other shellfish species. Such studies, therefore indicate a variety of potential specialized calcium derivatives could be obtained from a similar process utilizing such shells and fruit waste, and are claimed as well.

### Example Method of Processing Food Waste

Examination of Reaction 1A and 1B above shows that a key aspect of the removal of the calcium carbonate component of a crab shell or similar shell is the application of an acidic material to shell to allow a direct contact between the acid and the shell material. It has long been known that the contact area provided by simple or direct mixing is sufficient to allow vigorous reaction, and the corresponding release of copious quantities of carbon dioxide to the atmosphere. However, one of the limitations of this approach to chitin production is the need to obtain sufficient acidic material to provide the needed reaction capability. Since it is known that chitin comprised approximately 13-15% of the dry weight of a crab shell, the remaining approximately 85% of the shell is calcium carbonate. Therefore, for conversion of 100 grams of crab shell to 15 grams of essentially pure chitin, a quantity of acid is needed to react with 85 grams, 0.85 mole of CaCO₃ (MW of CaCO₃=100).

### Stoichiometric Considerations

Examination of Reactions 1A shows, 2 moles of acid are needed per mole of calcium carbonate, so one would need 2×0.85 moles of monovalent acid per 100 grams of shells. Commonly, hydrochloric acid (HCl) may be used in reaction 1A. In such implementations, 1.7 moles of HCL may be needed to react with 100 grams of shells. The product of the reaction of hydrochloric acid would be 0.85 mole calcium chloride (CaCl₂, MW=111) weighing 94.4 grams.

In the case of Reaction 1B utilizing a divalent acid, only 0.85 mole of the divalent acid would be needed. A typical acid candidate would be sulfuric acid (H₂SO₄) (MW=98) and the product would be 0.85 mole calcium sulfate (also called “gypsum”, MW=116) weighing 98.6 grams.

### Alternate Acids

Although other acid candidates are certainly possible, hydrochloric acid and sulfuric acids are by a considerable margin the least expensive and readily available across large parts of the world. However, both of these two are plagued by problems. Among the problems are the natures of the by-products of the reactions 1A and 1B. Calcium chloride (CaCl₂) from Reaction 1A is produced in quantities of approximately 94% of the initial dry weight of the shells. Calcium chloride has a limited spectrum of utility, and is also available from a variety of industrial processes. Most of the opportunities for profitable commercialization of it have been met with existing practice, and in fact calcium chloride is generally a surplus on these markets. Furthermore calcium chloride is highly hygroscopic. In the dry (dehydrated) state it very readily absorbs water from the air, which renders it useless for some applications. Some applications are suitable for the crystalline, hydrated state, CaCl₂-2H₂O (Calcium chloride dehydrate) but many are not. Preparing either the dihydrate state or the anhydrous version is very energy intensive, and as energy costs rise rapidly, the cost to make either form of calcium chloride becomes uneconomical, especially if transportation costs are considered. Therefore, there are significant economic disadvantages to using hydrochloric acid in reaction 1A.

Other difficulties of applications of by-product calcium chloride involve its highly corrosive nature relative to interactions with metallic features in the infrastructure, and its tendency to “salt up” the environmental features where calcium chloride is used. It has been widely utilized as a de-icing compound, particularly mixed with sand for application to roads. Those who live in regions where road salting is a common practice are well aware of the damage to metals of vehicles, to bridge structures and their metallic components. The economic costs of combating the corrosion losses from salt (CaCl₂) exposure may be very high. In some implementations, calcium acetate may be used as a de-icing compound, as it has a much-reduced profile as a corrosive agent. Specifically, calcium acetate is included as an anticorrosive agent in lubricants. Furthermore, the runoff from calcium chloride into agricultural sites, rivers etc. has forced many locales to convert to a more expensive and less effective (pound-for-pound) de-icing compound such as urea.

In some implementations, an alternative to hydrochloric acid, sulfuric acid is also fraught with difficulties. For example, the gypsum by-product created in reaction 1B is quite insoluble in water, rendering its removal and disposal problematic. Further, although gypsum has a number of uses in industrial and agricultural settings is a ubiquitous by-product, requiring large energy expenditures to isolate it. Correspondingly, gypsum has also saturated its markets, rendering another relatively new source uneconomical. Finally, sulfuric acid, when produced from fundamental materials requires the use of elemental sulfur which has become a relatively scarce commodity. This fact has forced the users of sulfuric acid to concentrate on the utilization of by-product acid, with corresponding transportation difficulties, environmental issues, etc.

For at least the reasons above, there is a need for a source of a relatively abundant and low cost system to provide the acid needed to remove calcium carbonate from shellfish shells, thereby providing low cost and sustainable access to a chitin resource. In addition, the desired acid source should be of low toxicity, and should be environmentally acceptable. A third criterion would be that the by-product of the carbonate-dissolving reaction would be of economic value, perhaps well beyond that of the previously discussed chloride and sulfate, and would provide properties that would render it superior for at least some specific applications.

One such candidate acid might be acetic acid. Previously acetic acid has been examined as a candidate and rejected on the basis of low reactivity with the shells. A second criterion of rejection of acetic acid is that it is relatively expensive, and generally must be obtained from biological sources, specifically the fermentation of the sugars of fruits, particularly as from the wine or apple cider industries.

The utilization of acetic acid obtained by the natural fermentation of fruit deserves reconsideration. Particularly from fruit sources that are unacceptable to market for other commercial uses. For example, spoiled fruit and/or mixed with a liquid component of apples, cherries, pears, cranberries and the like with contributions from apricots and others. Additionally, fruit waste may arise from fruit culls, from processing waste such as peels and cores, from slicing operations, from windfall fruit from harvesting processes that include the capture of twigs, leaves etc. In some implementations, the fruit waste may be stored for a time period sufficient to allow fermentation to be fully advanced but without any external disturbances, and without external energy inputs other than collection of the fruit and transportation of the mix relatively short distances to the chitin-extraction location. In certain implementations, the fruit waste has a relatively low pH near 4.5 or less (depending on fruit species and other factors) and has the ability to react readily with the calcium carbonate of crushed crab shells, evidenced by copious emission of CO₂ bubbles. The odor of the fruit waste may be quite strongly acetic in nature due to the fermentative conversion of sugars to vinegar (i.e. acetic acid). In some implementations, other fruit-derived or metabolically-derived acids may also be present.

Temporarily however, we will assume that the acid content is completely acetic acid, abbreviated HOAc. Assertions stating that HOAc is not strong enough to react with the calcium carbonate are incorrect. When the general kinetics of the reaction of crushed shells were examined, it was determined that a significant increase in the rate of the reaction when the mixture was heated to 140-160F. It was also determined that an expected decrease in reaction utilizing 5% white vinegar to simulate the performance of the fruit waste and dilution with water to simulate the performance of varying acid content as would be found in various batches of fruit waste. At the elevated temperatures reaction, as determined by CO₂ emission and bubbling rates, reactions consumed the acid content within a time frame of 1.5-2.0 hours. At the end of the period of elevated temperature, the bubbling reaction had ceased but could be restarted by addition of additional vinegar. This indicates that the original reactive component was expended but some shell carbonate remained un-reacted. These results can be summarized by Reaction 3:

2 HOAc (from fruit waste)+crab shell (CaCO₃)→Ca(OAc)₂+H₂O+CO₂. REACTION 3

It can be seen from Reaction 3 that the by-product in this case is calcium acetate. Calcium acetate is a highly soluble solid in the part of the solution left over from the reaction (solubility 37. g g/100 cc cold water, 29.7 g/100 cc hot water (CRC 61^{st}. Edn.). The mother liquor solution can thus be readily separated from the residual chitin by filtration and can be dried by any known technology, including solar drying. This isolated calcium acetate can be utilized in a variety of ways, including as in a de-icing compound. In the de-icing application it has significant advantages relative to calcium chloride. As described above, it is far less corrosive to metal objects, is not hydroscopic, causes far less environmental impact and does not, as far as is currently known, contribute to “salting up” the downstream soils and waters.

Although it is a major acidic component of fruit waste, acetic acid, as mentioned above, is not the only acidic material present in the fruit waste. Among the organic acidic components are citric acid, benzoic acid, other aromatic acids, propanoic acid, butanoic acid, diacids, triacids (including citric acids) carbohydrate-based acids, including short chain carbohydrate acids, oligomeric carbohydrate and polymeric carbohydrate acids, glycoprotein acids, nucleic acid products and the like. If desired, known chemical techniques could be applied to isolate these acidic components, after which the individual acids or selected combinations thereof could be utilized for any suitable purpose.

Among such purposes might be the reaction with a calcium carbonate source to produce high-quality version of the corresponding calcium salt. Thus among the disclosed applications of the invention are selected synthesis of a variety of calcium salts produced by reaction with the individual acid, isolated from the fruit waste, or mixed acids producing mixed salts. An alternative method for the preparation of said individual salts or selected mixtures thereof, would be to use the whole fruit waste mixture, followed by generally known chemical isolation techniques familiar to those known in the art.

Therefore, one implementation of the invention is the use of fermented fruit waste as an acid source to convert the calcium carbonate from shellfish shell waste to calcium acetate and chitin, meanwhile liberating carbon dioxide gas. This carbon dioxide can be readily captured and purified with known technologies, and can be sold for potential value added applications. Alternatively, in some implementations, it can be used as the gas source to drive a foaming process.

Another implementation of the invention is to provide a method for converting fruit waste into calcium acetate thus generating a value-added product that has utility in an environmentally, infrastructure, and vehicle friendly de-icing compound.

The process of removal of the edible substances from shellfish results in partly broken shells. Experiments with our composting process have revealed that such un-ground shells are generally suitable for composing by the methods described herein. Generally, partially ground or fully ground shell meal crab shell may be a useful additive to the conventional blend of composting materials and may provide several important compost ingredients. In some implementations of the method described hererin, the composting mixture reaches a temperature at which the breakdown of the shells is rapid enough that it is satisfactory in the absence of other steps. Some nutritive ingredients are provided by the crab shell material, while others are generated in the compost by metabolic or chemical changes as the compost is formed. Among these beneficial materials are nitrogenous products resulting from the protein components left behind in the shell meal. The shells are a rich source of, generally reduced products, including ammonia (NH₃) and small molecule amines (R—NH₂, R₂NH, cyclic and heterocyclic amines, aromatic amines etc) These N-containing products are, unfortunately, highly odiferous, in part because they are quite volatile, and in part because of human olfactory sensitivity to them. This odor drawback has contributed many of the difficulties that existing composting operations have experienced. Also, the volatilization of these compounds removes them from the arena of the composting process, and thus lowers the inherent nitrogen-fertilization value of the final compost. In some implementations, the methods described herein retains the N-content of the compost in the form of solids (generally organic salts), providing opportunity for the full utilization of the original N-potential.

### Odor Control

In some implementations, the utilization of the same or similar fermented fruit waste, particularly in compost or other applications involving the use of significant fractions of shell mash or shell waste, has additional benefit. For example, when the fruit waste mixture is added to a composting mixture with shell waste, an immediate chemical change occurs which considerably mitigates the odors associated with either of the two components taken individually. In some implementations, this chemical change occurs very quickly, within moments of mixing. The fruit waste is known to be of low pH (see above), and the odor components are expected to be, among others, volatile organic acids. The shell waste is known to initially contain protein materials which react (decompose) or metabolize via microbial action, to become volatile ammonia-related compounds. A strong ammonia odor typically associated with ammonia itself, and volatile amine compounds with closely related odors, apparently all very unpleasant, are associated with storage sites of the shell waste. Without wishing to be bound by any particular theory, one might speculate that the two components, one “naturally acidic” (fruit waste) and one “naturally alkaline” (shellfish waste) might be capable or being mutually “deodorizing” when mixed together in appropriate amounts. If that is so, the salts that instantly form from the neutralizing reaction, being non-volatile would “trap” the odor-causing organic acids and amines Such a reaction is shown semi-schematically as Reaction 4, where acetic acid schematically and generally represents the possible organic acids, and R—NH₂ schematically and generally represents volatile organic amines or ammonia:

HOAc (volatile organic acid)+R—NH₂ (amine compound)→R—NH—OAc+H₂O REACTION 4

R—NH—OAc is a salt or an organic amide, neither of which are significantly volatile at ordinary temperatures, therefore neither have a strong odor.

Examination of Reaction 4 shows that there is a stoichiometric relationship between the acidic and alkaline components of the reaction. While this relationship exists, the uncertainties of the exact compositions of the shell waste and the fruit waste make predicting the precise amounts of each to use difficult. An empirical approach, utilizing a fixed amount of the solid component, shell, and gradually increasing the amount of the liquid component to reach minimal odor is particularly preferred. Of course, any means by which the two components are blended in practical application for minimal odor is contemplated within the scope of this invention. The efficacy of this approach to odor control has been verified at laboratory scale and at industrial scale. Nearly complete loss of the objectionable odors of the two main components is observed at both scales.

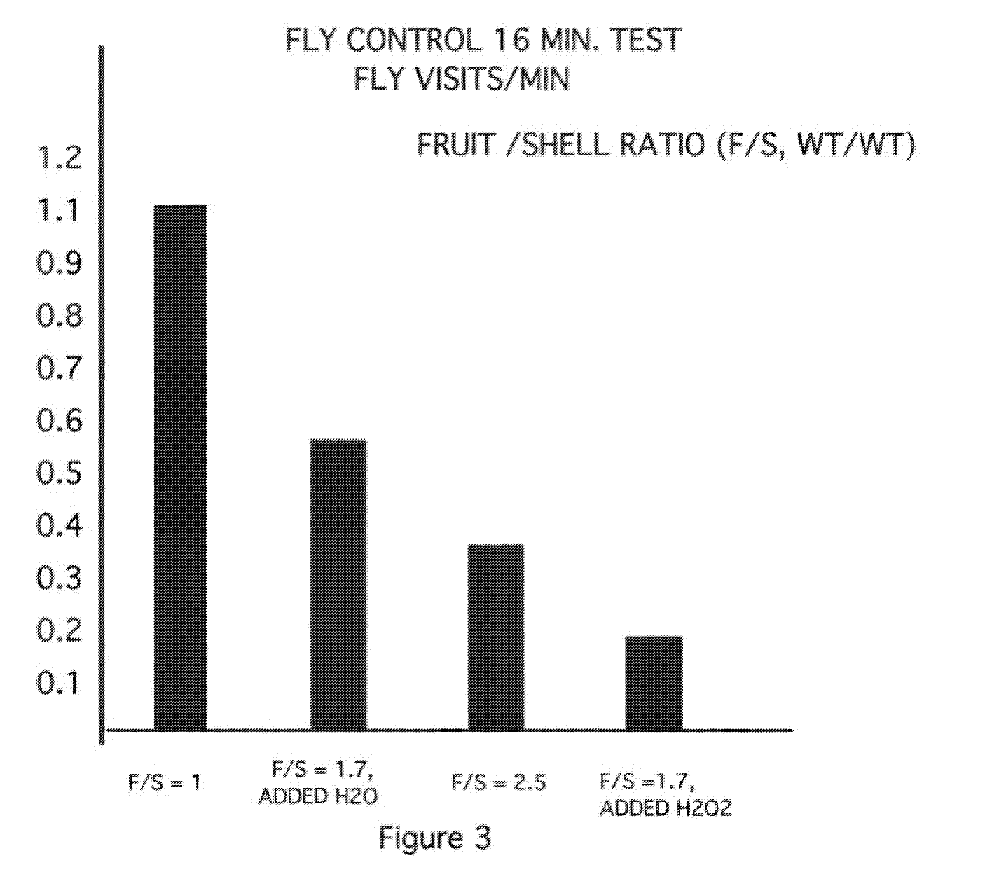

An experiment was performed to roughly measure the preferred ratio of fruit waste to shrimp shell waste, with specific reference to odor control. Three mixes were made with strongly odorous 4-day-old pressed shrimp shells. These shells very readily attracted fly hoards in a few minutes of exposure to outdoor air. The wet shells were divided into four equal-weight samples, each sample treated with an amount of fruit waste ranging from 1:1 by weight to approximately 2:1 fruit : shell, and where water was added to maintain a roughly equal total added liquid volume. The 4th sample was also treated with an amount hydrogen peroxide, providing about 0.5-1.5% H₂O₂ in the mix along with the fruit waste/shrimp mix. The samples were then set outside for exposure to freely ranging flies. As expected, there was a dependency of the number of flies attracted to the amount of fruit waste: greater waste correlated to reduced fly attraction. The presence of the small amount of hydrogen peroxide in the 4th sample almost completely eliminated any attraction for flies. During the observation period, a number of flies landed on the first three samples. Only two flies were seen on the 4th sample containing the peroxide mixture. FIG. 3 illustrates a bar chart indicating the number of fly visits per minute of the observation period for each sample. The samples were preserved at room temperature in a fly-reduced protected area for two days, then reintroduced into a fly-rich area. Flies were immediately attracted to all four samples, with no significant difference between the fruit waste-only samples and the fruit waste plus hydrogen peroxide sample. As an additional test, 2 mL of 3% hydrogen peroxide was added into Samples 2 and 4 and stirred in well. Recall that only Sample 4 had been originally treated with fruit waste and peroxide, while Sample 2 was treated only with the fruit waste. Surprisingly, both samples experienced considerable foaming, presumably from either the lingering presence of an hydrogen-peroxide reactive enzyme, again presumably a catalase enzyme, or perhaps the presence of a metabolizing microorganism providing a fresh source of catalase, which catalyzed the liberation of oxygen from the peroxide as shown by Reaction 5:

2 H₂O₂→2H₂O+O₂ REACTION 5

As the O₂ was released, the mixture increased in volume, approximately by a factor of 10-20%. Both these samples were then again fly-free for about 1 hour, at which time, odor considerations forced the discarding of all the samples. Meanwhile, the samples 1 and 3 which remained untreated with peroxide (but still in close physical proximity) were heavily infested with flies.

The effect of hydrogen peroxide on the samples is interesting for at least two reasons. First, hydrogen peroxide is toxic to macroscopic and microscopic organisms, and therefore would be expected to be deleterious to the composting microorganisms, thereby stopping their progress. However, the continued progress of the formation of highly odor-causing metabolism indicated that they survived direct exposure and continued to function. Second, the fact that the enzyme needed to catalyze Reaction 5 was still present in or on the shells after at least 4-5 days is remarkable and unexpected. With few exceptions, enzymes are generally considered to be very unstable when outside the living tissue in which they normally exist. These shells had been broken open and the edible tissue removed, the inside surfaces of the shells exposed to ambient air, pressed and crushed to reduce their moisture content significantly, and stored at ambient temperature. That the oxygen-producing reaction still occurred readily is indeed unexpected, but might also be accounted for by the hypothesis that the microbial organisms present in (and probably contributing to) the decomposition of the remaining biological materials of the shell, might contribute significantly to the presence of catalase or similar enzymes that contribute to peroxide breakdown. Furthermore, the fact that it did occur is of value because the hydrogen peroxide content that contacts the microorganism species will be of reduced concentration, thus providing a reduced-toxicity environment. The fact that the hydrogen peroxide initially can suppress microbial activity but then leaves behind no toxic or damaging by-products may also provide a potential advantage.

From the peroxide-related and fly-avoidance results mentioned above, at least two practical applications of the fruit waste/shell are apparent. First, the addition of an effective amount of dilute hydrogen peroxide to the fruit waste prior to the blending with shell waste has the effect of reduction of the odor problem associated with shell waste, and that this effect exceeds the effect of an effective quantity fruit waste alone. Second, addition of the peroxide can renew the anti-fly effect of a combination of shell waste and fruit waste, whether the original shell waste treatment is accompanied by peroxide or not. Thirdly, the foaming action caused by O₂ release provides additional effects. For example, lowering of the bulk density of a composting body because of the gas volume. Another valuable effect may be the increase of the O₂ potential generated within the bulk body of the compost, which provides a means to limit or control the degree of or the balance between aerobic and anaerobic metabolic process and/or bacteria populations. Because the O₂ is formed in situ, it will be more uniformly distributed and therefore more effectively controlled than corresponding levels achieved by typical stirring actions.

In some implementations in which a bubble-forming or foaming action is desired, a small amount of compatible foaming agents or foam stabilizers can be employed. These agents are well known to those familiar with the art, and can vary widely in chemical structure. They are generally surfactants, and can be categorized as cationic, anionic, zwiterionic, quaternary amine products, nonionic species, catrionic polymers, anionic polymers, non-ionic polymers and the like.

Examination of Reactions 1A and 1B show that they, too, emit a gas when they occur. In those cases, the emitted gas is CO₂. Recalling that these reactions occur when the fruit waste is reacted with shells that contain calcium carbonate, either in the form of chitin-carbonate composite (crabs, lobsters and the like) or when shells with minimal or no chitin is present (oysters, clams, mussels and the like), the reader can appreciate that the benefits of bubble-formation or foaming are available in such cases as well. For efficient bubble-formation or foaming, foam-building surfactants, essentially as those mentioned above are applicable.

In some implementations, the use of fruit waste for odor control and for other purposes (calcium acetate production etc.) means of applying the fruit waste material to the shell-based material is of importance. Several variables need to be taken into account if successful odor control and other benefits are to be realized. Among these are the levels of acidic components, other components of the fruit waste, the pH, the amount and age of the shell-based materials, the temperatures, the particle sizes of the shell particles, the degree of mixing etc. Ideally, two main variables might also be considered: The system might be mechanically agitated, i.e. a flow-based system, and a static i.e. standing or pool-like system. In either case, the extent to which the fruit waste liquid can interact efficiently with the solid shell-based materials is of importance. In a static or semi-static system, the exposure time of the liquid and solid can, for example, be extended as needed for full reaction by simple standing after mixing. While this might require increased tank volumes, it is generally straightforward. On the other hand, a flowing or tumbling system used to create the liquid-solid exposure might allow a much more limited time. Another consideration is that the volume of applied fruit waste might be significantly less than that of the bulk shell volume. The volume of fruit waste might be sufficient to contain sufficient reactant for full benefit, but the limited contact might not be adequate In such cases, it is anticipated that viscosity control of the fruit waste might be of value. Although the hypothesized acid-base reactions are known to be essentially very rapid, bringing the acid and base into direct physical contact might be significantly slower because of penetration effects, mixing effects and the like. If that should happen, the deodorizing effect might be relatively and undesirably slow. Since the fruit waste is generally of very low viscosity, the tendency to drain off rapidly might also leave materials un-reacted. Therefore it is contemplated that thickeners, gelling agents, and other viscosity modifiers could be utilized in the fruit waste liquid. A number of such agents are known to those familiar with the art, including cellulose-based (CMCs) starch based, hydroxypropyl methyl cellulose (HPMCs) based, pectin-based, derivatives of vinyl and polyvinyl alcohol or polyvinyl chloride based, vegetable and many others are known. The utilization of any of these or others, or mixtures of these to produce the desired thickness enhancements are anticipated and claimed. In some cases, it might also be desirable to utilize solid or gelled materials as carrier bodies for the acidic components. In such embodiments, the shell waste could be tumbled or otherwise stirred with the carrier material to provide a reactive or deodorizing function for the shell waste. By providing prolonged contact between the shell waste and the deodorizing components of the fruit waste fuller utilization of the chemical potential of the needed acidic compounds, and the corresponding economies from lower usage per ton of shell waste could be realized.

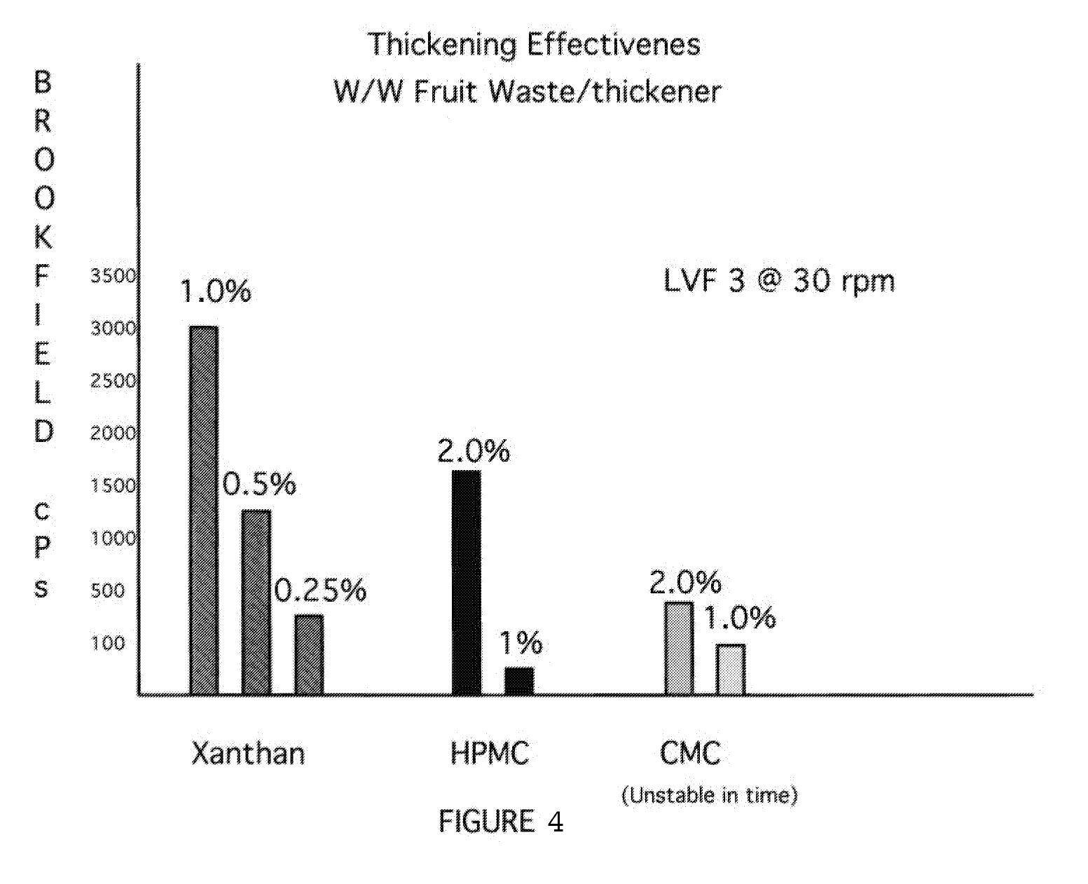

See FIG. 4 for an example illustration of the viability of various representative common thickeners in the fruit waste liquid. Briefly, all the common thickeners tried were able to thicken the fruit waste mixture. However, several of those tried, most particularly the CMCs lost their thickening effect on storage over several days. Whether this loss of thickening effect was due to chemical effect (acidic chain-shortening, for example) or due to metabolic breakdown from the presence of live microbes present in the fruit waste was not determined. Whatever the cause, the abbreviated study performed strongly supported the use of Xanthan gum as the most cost-effective and functioning gum, so Xanthan is the most preferred embodiment for fruit waste thickeners.

It should also be noted that the use of the fermented fruit waste can be applied to the control of “fishy” odors when fin fish oils or fin fish by-products are included in composting operation. This discovery is unexpected and counter to common sense, since the mixing of two or more very smelly materials would not be expected to produce a less odor-bearing mixture. The use of fin fish waste with fruit waste for odor control would, if successful, provide an empirical verification of aspects of the reaction hypothesis, depending, of course, on the presence of alkaline, ammonia-like components in the fish odor volatiles.

### Fly and Other Vector Control

An additional particular benefit of the utilization of Reaction 4 in composting operations is related to the odor-reduction feature. Typical composting operations experience problems with fly populations and a number of measures must be typically done to prevent large infestations of flies. It is generally accepted that the flies are attracted to the volatile, odoriferous compounds usually released. Reaction 4 shows the fruit waste/protein waste combination causes a very considerable loss of the levels of the volatile compounds, converting them to non-volatile forms. The odors are thus at levels that dilute readily into the surrounding air and do not provide large volumes of downwind attractive zones that can be detected by flies, thus reducing their numbers by significant magnitudes. A fruit waste/shellfish compost pile (experimental-but with essentially identical size, shape, geometric dimensions and location) was placed between two ordinary (control) composting piles. The fly hoard around the two control piles, as is ordinarily seen, was essentially missing on the control windrow.

### Experimental Tests of Fly Control Effects

Test 1: Fly Trap Experiment:

To test the validity of the observation that fruit waste can prevent fly hoards from accumulating on shell-based composting systems, two identical, commercially available fly traps were placed in near proximity to each other, in the composting area normally plagued with flies. The traps were both baited with crushed crab shell. Trap 1 had the crab shells untreated. Trap 2 had the same amount of shells, where the shells had been pre-treated by mixing with an equal volume of the fruit waste described above, then shaken to remove the excess liquid. The traps were then hung as described above, and left undisturbed for 6 hours. At the end of the trial period, the traps were examined and weighed. Trap 1, untreated, had accumulated enough flies to add 1 lb to the trap weight. This would correspond to several thousand flies. Meanwhile, the treated shells were essentially fly-free, as only six individual flies were counted.

Test 2: Fly Visit Quantification Experiment:

The shells had been acquired fresh at a processing plant in Washington State on Jun. 21, 2012. Since the shells were freshly removed from the edible shrimp meat, they had very little odor. The fresh shells were placed in sealed plastic bags, and stored outdoors (temp approx; 45F) until Jun. 25, 2012, by which time they were very odiferous, odor primarily ammonia-like and similar to putrefied flesh. The odors were strong enough to attract black flies on brief opening of the container for sample removal. The four 10-gram samples were weighed out and placed in shallow plastic cups. Each sample was treated with 10.0 grams of fruit waste liquid and distilled water. The cups then contained:

TABLE 1

Sample 1: 10.0 g as supplied (wet) shells; 10.0 g fruit waste; 15 g
H₂O: Total added liquid = 25 g
Sample 2: 10.0 g shells, 25 g fruit waste; 0.0 g H₂O: Total
added liquid = 25 g
Sample 3: 10.0 g shells, 17 g fruit waste; 12 g H₂O: Total added
liquid = 27 g
Sample 4: 10.0 g shells, 17 g fruit waste; 8.0 g H₂O and 8.0 g
3% USP drugstore H₂O₂: Total added liquid = 33 g

The cups were then placed outside in sunshine and observed for 16 min, in 4-minute intervals. Each 4 minutes, the flies present were shooed away, and the count was restarted. Both fruit flies (F) and black flies (B) were counted. No attempt was made other than the shooing to avoid multiple counts of an individual fly. FIG. 3 summarizes the data from this experiment, and Table 2 presents the raw data: Code used: F=count of fruit flies; B=count of black flies

TABLE 2
FLY CONTROL DATA

0-4 min.
Sample 1: F = 1, B = 5; Sample 2: F = 0, B = 2; Sample 3: F = 0,
B = 2; Sample 4: F = 0, B = 1
4-8 min:
Sample 1: F = 1, B = 5; Sample 2: F = 1, B = 0; Sample 3: F = 0,
B = 3; Sample 4: F = 0, B = 0
8-12 min:
Sample 1: F = 0, B = 5; Sample 2: F = 0, B = 2; Sample 3: F = 0,
B = 2; Sample 4: F = 0, B = 0
12-16 min:
Sample 1; F = 0, B = 1; Sample 2: F = 0, B = 2; Sample 3: F = 0,
B = 2; Sample 4: F = 0, B = 0

From this data, it is clear that addition of a small amount of hydrogen peroxide to the odor-reduction formula has a very strong negative effect on the attraction of the shell waste for flies of both types. Further, it can be seen that the solution where amount of shells vs the amount of fruit waste, on a w/w basis is approximately 1:1 is less effective that when the ratio is somewhat greater than 1 part fruit waste. However, apparently 100% fruit waste solution, undiluted, is not significantly more effective than when it is diluted, provided the weight of the fruit waste exceeds the weight of the pressed shells by a margin of approximately 1.25:1 or more.

During the work on odor reduction and fly reduction, an additional effect was a observed. When fruit waste is exposed to environmental air, it is highly attractive to indigenous birds. The same attraction is seen. But when the fruit waste is blended with the crab shell components, a composting mixture is obtained which is not attractive to birds. It is hypothesized that the chemical reactions which reduce the odorants relative to human senses and simultaneously reduce those that attract flies also reduce the odorants that attract birds. Alternatively, the reduction of the fly population might reduce the attractiveness to birds by loss of the flies as a food source. Whatever the reason, this effect can significantly and positively impact the practice of composting by reducing the normally troublesome populations of birds and their associated filth, disease vectoring, noise etc.

This is a particularly interesting result because it suggests that the volatile substances which act to attract flies are undergoing one or more chemical changes, as are those substances that are obnoxious to humans, albeit they may well be undergoing different reactions and producing different products. It is not obvious that such would be the case, since it is known that flies are often attracted to a different complex of volatiles than those responsible for human odorants. For example, it is known that mosquitoes are attracted to humans via their exhaled CO₂ gas. CO₂ is an odorless gas to humans but strongly attracts mosquitoes.

Example Stored Shellfish Implementations

In some cases, the shellfish shells are produced at a rate that is inconvenient for the transport system or for the composting process. This situation can also arise from inconsistent shellfish catch situations, slow catch situations, fishing weather and the like. In such cases it is often necessary to “warehouse” the shells for a period sufficient to allow the odor-causing reactions to occur. This causes a problematic situation, particularly if the shellfish waste storage area is located in a populated area. Thus the need arises to reduce the odor-causing reactions during the warehousing phase. It has also been observed that during this warehousing phase, it is sometimes the case that an initial application of the fruit waste, while it initially almost perfectly removed initial odors, severe odors can re-occur after several days. Still another problem can arise because the initial application of the liquid fruit waste is partially removed in the standard shellfish waste treatment process by pressing or squeezing the shellfish shells in a compactor. This compacting is of value in that it avoids the expense of transporting water and other fluids to the composting site, but it simultaneously reduces the available quantity of fruit waste, thus allowing the odor-causing reactions to become predominant again, perhaps before the warehousing stage is complete.

In order to avoid these problems, another embodiment of the invention is to pre-treat the shellfish waste with a fruit waste solution that is able to delay or retard the odor-causing reactions. Prolonging the viable warehousing period or the time to transportation or the time to destination is achieved. This embodiment utilizes the fact that the primary compounds in the shellfish waste odor-suite are, as mentioned above, amine compounds and/or close chemical relatives. These compounds are reactive to acids, such as fruit acids in the fruit waste, and are generally converted to amine salts. These salts are generally non-volatile, are therefore odorless, and remain trapped in the solution or in the solid residues associated with the overall mixture. But to preserve the odor-trapping features of the invention, the acid components cannot be allowed to escape, via reaction or by evaporation before they can do the trapping. This suggests that an acidic buffer system would help prolong the odor reduction.

It is well known that acidic buffer can be prepared in by mixing a weak acid with a metallic salt of that weak acid. Further, both the acid and the salt of the weak acid must be soluble in the (aqueous) solution. Thus this invention contemplates the use of the reaction between the fruit waste acids (i.e. weak acids) and the calcium carbonate of the shellfish shells to produce the needed buffer system. This system will produce the needed buffering to absorb the amine odors as long as the acidic component survives. The salts produced (e.g. calcium acetate) will remain more or less in place if the solution tends to “go dry”. Alternately, the fruit waste can be thickened with a thickener, e,g, Xanthan gum or the like, preferably before the combination with the shellfish shells, so that the calcium acetate of the buffer system is produced more-or-less homogeneously within the solution that is in contact with the shells. If that solution goes dry, the calcium acetate than be reclaimed by a water-washing step if desired.

If chitin-free shellfish shells are utilized, no calcium carbonate will be present for the needed reaction to generate the buffer system. In such cases, it is contemplated that crushed oyster, clam. Mussel, abalone shells or similar, chosen from the list of non-chitin shells, can be crushed and added to the fruit waste mix. If done prior to the mixing with the non-carbonate shells, the buffer and/or the thickener can be already in place. In some cases, the thickened fruit waste might cause the decarboxylation reaction to be excessively slow. It is contemplated that a rinse step which will act to dilute the fruit waste, followed, if necessary by placing additional fruit waste and/or a heating step will accelerate the reaction to desirable rates. If it is desired to capture the salts washed away by the dilution step, a filtration, a settling, a centrifugation or other known techniques can be utilized.

Other applications of the instant invention are contemplated. For example, the coastlines of the Northwest US are often rich areas of cranberry culture. Waste from the cranberry fruit can be utilized in a manner similar to that from orchards and vineyards. Fortuitously, such cranberry harvests often take place in close geographic proximity to fishing and shellfish harvesting industries. Acids from cranberry waste are of significant interest in light of the invention. Similar combinations might be operational in New England and Chesapeake shellfish industries where these two wastes occur in relative proximity.

The Great Lakes region of the US, for example along the eastern shore of Lake Erie is a large grape-growing area. Grape waste (and wine-making waste) could be utilized for odor control associated with large volume environmentally associated fish kills that often contaminate Great Lakes beaches.

Similarly Peach-growing, apricot growing and berry-growing areas would be candidates for the generation of appropriate fruit waste. Wine-production fruit waste would be of value in the shellfish fisheries near the coastline of Northern California.

It should also be noted that a number of other shellfish industries could benefit from the utilization of the reactions between fruit waste components and the waste shells of shellfish, even if such shells do not contain a significant chitin component. All such shells, for example clams, oysters, and mussels and the like are composed of calcium carbonate, and are generally provided by nature with a protein-related thin protective coating that can lead via decomposition to strong odors, especially when stored in large accumulations (see above discussion of oyster shell chemical content). This invention contemplates that a spray, wash or dip based on the fruit waste can be developed which would neutralize the odor-causing volatile compounds. Passing the shells through such a treatment on the way to storage in piles, for example, would significantly reduce the impact of such odors. In some cases, the treated shells might them be crushed or otherwise reduced in particle size, followed by a pressing or other fluid reduction step In some cases, the resulting fluid might posses more reactive potential, and could be captured and reused. Alternatively, its odor-production properties might be reduced sufficiently that it has no further reactive potential, in which case it could be discarded or in some cases utilized as irrigation water.

Additionally, in situations where the calcium-derived compounds such as calcium acetate, calcium citrate and the like would have economic value in excess of the shells themselves, the fruit waste could be utilized to convert the shells to such products. This application is also contemplated and claimed.

The above-mentioned spray system might be utilized further by providing a clarifying filtration step to remove excess solids content, so that fine spray is possible. This spray can be applied to, for example, concrete and wooden structural areas in fish- and shellfish-processing areas to reduce the residual odors that accumulate in such places. In those applications, addition of a small amount of a wetting agent to the fruit waste, and in some cases an anti-foam agent would allow deep penetration by the spray, thus rendering the areas more pleasant as workplaces, reducing environmental costs and the like.

Another candidate for deodorization by fruit waste would be the wooden (and/or polymeric) boxes or totes in which fish, shellfish and related products are handled and transported. Such boxes accumulate decaying fish-related debris and are the sources of some of the worst odor-bearing components in the industry. Application to box-odor reduction is contemplated and claimed in this invention.

In order to utilize the embodiments of the invention, it will, of course, be necessary to bring the major components of the process together in a locus. A common problem associated with this need is that transportation of odor-bearing materials, usually but not always the shell components involve the use of the public transportation infrastructure, particularly the highway system. Transportation laws and rules can be a barrier to allowing the needed ingredients to be brought together in the quantities needed. Therefore, another application contemplated by the invention is to pre-treat shell waste with the fruit-waste at or near the site of the shell production facility. In this way, the shell waste's odor-causing ingredients are reduced to acceptable levels, allowing highway transportation to be utilized. Application of the fruit waste to the shells, followed by stirring or other agitation, followed by agitation or other means of mixing, then allowing the fruit waste liquids to be drained off or otherwise separated, by means known to those familiar with the art is contemplated.

It is also contemplated that the reverse process is possible, specifically that the shells can be transported to the site of the production of the fruit waste, where the similar mixing process could be accomplished. While this scenario is less likely to be utilized because of the lower level of odor related to fruit waste, it is contemplated as an alternative embodiment of the invention.

Another embodiment of the invention is contemplated wherein the shell/fruit waste mixture, perhaps combined with other nutrient additives, amendments and the like could be more readily stored and/or utilized if the combined material was a form which lends itself to handling by bulk-handling equipment. Rather than providing the shell/fruit-waste material as a simple mix, it is contemplated that it could be pelletized or otherwise converted to chip-form, worm-like shapes etc. These compacted shapes would be bagged, handled in super-sacks and the like, moved by conveyor, bucket-line, front-loaders etc. In order to provide the binder material to consolidate the pellets into a single moldable shape, a portion of the fruit waste itself (perhaps even prior to the fermentation or storage stage) could be concentrated by evaporation to a syrup-like consistency. This syrup would have a binder effect since it contains a number of sugars and sugar-like components, and even some proteins and protein-like ingredients which are binder-like and/or sticky. This binder would readily break up on exposure of the pellets to moisture in the composting mix. Similarly, the pellets could have an additional benefit in that they could provide a low-moisture ingredient, thus provide a means to readily lower the total mix moisture content in a short time.

Examples of materials which the invention contemplates includes but is not limited to calcium acetate, other calcium salts, chitin, chitosan, fully composted products, partially composted products, blends of salts and other agriculturally significant materials as candidates for pelletizing.

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A method for producing compost comprising:
contacting shells from one or more shellfish with fruit to form a mixture,
maintaining the mixture for a time sufficient to form compost,
wherein compost is formed in less than eight weeks.

2. The method according to claim 1, wherein said fruit includes fruit that is at least partially fermented.

3. The method according to claim 1, wherein said shells are crushed shells.

4. The method according to claim 1, wherein said shellfish is a crab, a clam, an oyster, a shrimp, a lobster, a mussel, an abalone, a scallop, a crayfish, a limpet, or a common periwinkle.

5. The method according to claim 1, wherein said fruit includes fruit waste.

6. The method according to claim 5, wherein said fruit waste includes spoiled fruit, fruit peels, fruit seeds, fruit stones, or any combination thereof.

7. The method according to claim 1, wherein said fruit has a pH of 4.5 or less.

8. The method according to claim 1, wherein the shells and fruit are contacted at a ratio of about 1:1 to about 2:1 fruit to shell.

9. The method according to claim 1, wherein an odor associated with the mixture is less than an odor associated with the shell, the fruit or both prior to contacting.

10. The method according to claim 1, further comprising agitating said mixture.

11. A method of producing a product comprising composing shells from one or more shellfish with fruit, until a product is formed,
wherein said product comprises a calcium salt, chitosan, chitin or any combination thereof.

12. The method according to claim 10, further comprising isolating the one or more calcium salts.

13. The method according to claim 10, the shell and fruit composition further comprising a peroxide, wherein the peroxide comprises about 0.5-1.5% of the composition.

14. The method of claim 10, wherein the shells and fruit are composed at a ratio of about 1:1 to about 2:1 fruit to shell.

15. A method for reducing odor associated with shell waste from shellfish comprising contacting said shell waste with a fruit product.

16. The method according to claim 15, wherein the fruit product includes fermented fruit with a pH of 4.5 or less and at least one of a thickener or a gelling agent.

17. The method according to claim 15, wherein the shell waste is crushed shells from at least one of a crab, a clam, an oyster, a shrimp, a lobster, a mussel, an abalone, a scallop, a crayfish, a limpet, or a common periwinkle.

18. The method according to claim 15, further comprising contacting the shell waste and fruit product with a peroxide, wherein the peroxide comprises about 0.5-1.5% of the shell waste and fruit product composition.

19. The method according to claim 15, wherein contacting the shell waste with the fruit product produces a calcium salt, chitosan, chitin or any combination thereof.

20. The method according to claim 15, wherein an odor associated with contacting the shell waste with the fruit product is less than an odor associated with the shell waste and an odor associated with the fruit product prior to contacting.
